(19) United States
(12) Patent Application Publication
(10) Pub. No.: US 2009/0210453 A1
(43) Pub. Date: Aug. 20, 2009

(54) Service for verifying consistency of replicated data

(75) Inventors: Claus Vetter, Buchs (CH); Thomas Werner, Baden (CH); Jan Bugge, Sandvika (NO); Gorm Sande, Slependen (NO)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 10/592,865

(22) PCT Filed: Mar. 17, 2004
(86) PCT No.: PCT/CH2004/000159

§ 371 Date: May 5, 2009

(51) Int. Cl. G06F 17/30

(52) U.S. Cl. 707/201; 707/E17.009; 707/E17.032

(57) ABSTRACT

Any external application using data access functionality can use the attribute consistency service to update and synchronize attribute value for an entity. The application can access the relations of an entity, which are stored in an entity reference database. In case of inconsistent attribute values, a master attribute value is determined which is then written to the defined attributes of the applications.

The consistency of data stored in various IT systems can be ensured prior to attempting to access it. Errors by calling a service or functionality that would require access to data that is not available or that is inconsistent are therefore avoided.

### FIELD OF THE INVENTION

The invention relates to the field of utility automation.

It relates to a method for ensuring consistency of entities stored in data sets of a multitude of different IT systems used for operating utility automation assets.

### BACKGROUND OF THE INVENTION

With the deregulation of energy markets, focus in utilities shifts towards optimizing the internal business processes. On the IT system side, navigation between, synchronization and retrieval of information stored in the various data sources in operation (e.g. SCADA—supervisory control and data acquisition, CMMS—computerized maintenance management systems, GIS—geographic information system) is a challenge.

All applications work on the same “world view”—physical assets in utility operations, such as stations, lines, transformers, breakers, regions and areas. These assets are modeled in the various applications and carry specific attributes with them. However, a consolidated access to this information is cumbersome and maintenance efforts for the data stores are huge. Examples here are network modifications, such as commissioning or disposals of assets, which subsequently imply changes in the IT application data sets.

To overcome the challenges of interoperability between the named systems, integration applications are being developed. One example is the access to data and exchange of data between the participating applications as shown in FIG. 1.

As soon as relationships between these assets—further referred to as entities—in different data sources are defined, consistency of those relationships becomes a relevant issue for applications, which rely on those relationships. In all participating applications data, which belongs to the entity, will be stored and some of this data will be duplicate in those applications. (e.g., the maximum operating temperature of a transformer will be stored in both the SCADA system for operational purpose, as well as in the CMMS system for maintenance purposes). It becomes apparent that keeping this common data—further referred to as attributes of an entity—synchronized between the application is crucial in order to ensure a correct and smooth operation of the IT system.

Today, a number of IT systems are in operation in utilities, with which the different facets of utility operations are managed: a SCADA system carries an electrical view on assets (electrical network) in order to open/close breakers, monitor voltages, currents or capacity limits. CMMS, such as SAP PM and GIS, such as ESRI, are used for maintenance management for physical assets. The first one contains (active and archived) work reports, new work orders, allows dispatching crews, whereas GIS is used to optimize maintenance operations through the spatial view on the assets.

Each system comes with specific tools and applications, which allow users to modify the underlying data sets, both for an initial setup and continuous updates. Furthermore, the applications have different access technologies to their data stores: SQL, OPC, file import/export, and others.

Since the responsibility for the systems usually lies in the different service departments of a service provider (SCADA—operations, CMMS/GIS—maintenance), changes to the data set of those systems are done through a manual process, e.g., using paper, phone, or e-mail between responsible persons in the different departments. This process is error-prone, and often leaves the utilities with incorrect data sets with their applications.

Adapting attributes, such as e.g. operational limits for an asset, which are contained and maintained in the data sets of the different systems, becomes even more difficult.

### DESCRIPTION OF THE INVENTION

It is an object of the invention to reduce malfunctions of utility automation IT systems due to inconsistent data.

This is achieved with a method for ensuring consistency of attributes of entities stored in data sets of a multitude of different IT systems according to claim 1.

The inventive method allows validating consistency of attributes of an entity with common attributes in more than one of the participating applications and restoring consistency if any of the attributes of an entity is found to be inconsistent.

The attribute consistency service is called either before a functionality is triggered, used by applications such as navigation (e.g. navigate to the transformer from SCADA to CMMS), or continuously, to check and ensure the consistency on the relations stored in the external data store.

With the inventive method, the consistency of data stored in various IT systems can be ensured prior to attempting to access it. The feedback given to the calling application allows that application to offer a certain service or functionality only if the required data is consistently available. Errors by calling a service or functionality that would require access to data that is not available or that is inconsistent are therefore avoided.

Existing applications need not to be modified since either a polling mechanism through adapters is used to acquire the needed information from the applications or the adapter will react on events from the applications.

Since the relationships of entities and their attributes are stored in an external database, the attribute consistency service can be used for several applications, such as navigation or data access.

Furthermore, the number of participating applications is not limited. Adding additional IT systems to the attribute consistency service only requires extending the reference model stored in the attribute consistency service reference database.

### BRIEF DESCRIPTION OF THE DRAWINGS

The invention will be explained in more detail in the following text with reference to the attached drawings, in which:

FIG. 1 shows an exemplary data flow between integrated IT systems,

FIG. 2 shows the reference modeling of a ‘real world object’

FIG. 3 shows the setup of the attribute consistency service system, and

FIG. 4 shows a detailed block diagram of the functionality of the inventive attribute consistency service system of FIG. 3.

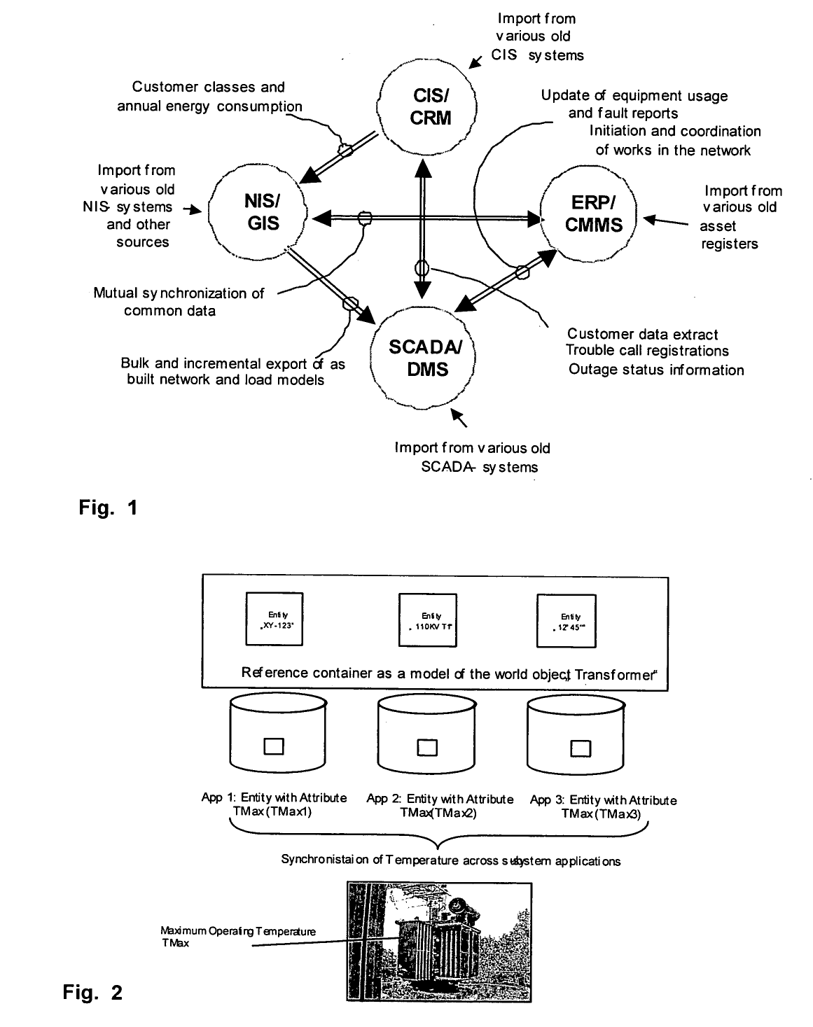

### DETAILED DESCRIPTION OF PREFERRED EMBODIMENTS

A service which knows about the relationships of the attributes of an entity and knows about the access to the individual entity data stores of the participating IT systems applications allows external applications, such as navigation or data access to perform a consistency check before a functionality is triggered, or the consistency is alternatively checked continuously on the relations stored in the external data store.

For each application which holds data sets (e.g., CMMS, GIS, SCADA), an adapter manages the specifics to communicate against the application and hide access to the application APIs towards this service. The adapter provides functionality to 1) retrieve the attribute value from the participating applications and to 2) write an attribute value to a participating application.

Keeping the attributes of an entity across applications consistent involves two basic steps: 1) Detecting inconsistencies of attributes, and 2) Restoring consistency of the attributes.

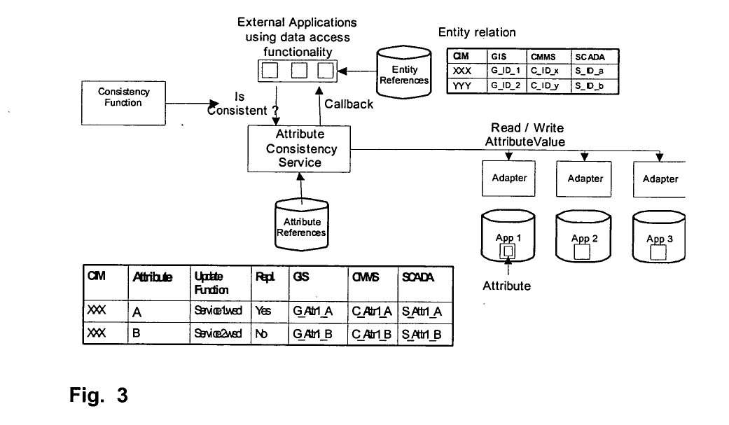

The setup of an attribute consistency service system is shown in FIG. 3.

Any external application using data access functionality can use the attribute consistency service to update and synchronize attribute value for an entity. The application can access the relations of an entity, which are stored in an entity reference database. The entity reference contains the names of the entity in the participating applications as well as an identifier for the entity reference (e.g. CIM:XXX). The Attribute consistency server reads the attached attributes for CIM:XXX from an attribute reference database. This contains the entity reference CIM:XXX, the attribute reference A which is common to the entity CIM:XXX in all participating applications, the according update function or update service description (e.g. service1.wsdl) needed to update that particular attribute, a flag for setting an automatic or user driven synchronization and the names of the attribute in the participating applications. With the entity name and attribute names the attribute consistency service can check the consistency of the attributes of the entity in the different IT systems by comparing the values of the attributes from the participating applications and initiate the update process if necessary.

In case of inconsistent attribute values, a service function gets invoked to determine a master attribute value (MAV) with the attribute values being the function parameters. The service function can be freely defined during engineering phase or be chosen dynamically depending on the current situation of the modeled entities (e.g. Median function, definition of a master application whose attribute value overwrites the other applications attribute values etc).

A predefined Replication flag (YES/NO) indicated if the user or an external overwriting confirmation application should confirm the synchronisation process. The result of the service function, the MAV is then written to the defined attributes of the applications.

The inventive system comprises an attribute consistency service with an input buffer, output means and communication means to communicate with the adapters of the various IT systems.

An external application registers at the consistency service to be notified on consistency feedback. This calling application can place an entity for which the consistency must be ensured in the buffer, and will get notified as soon as the entity has been processed by the service.

In another approach, a batch application can place a set of entities, or relationships, as defined in the external data store, into the buffer for cyclic checks. No callbacks from the service are triggered. Instead, inconsistent data sets are logged by the service in order to include those in a re-engineering process.

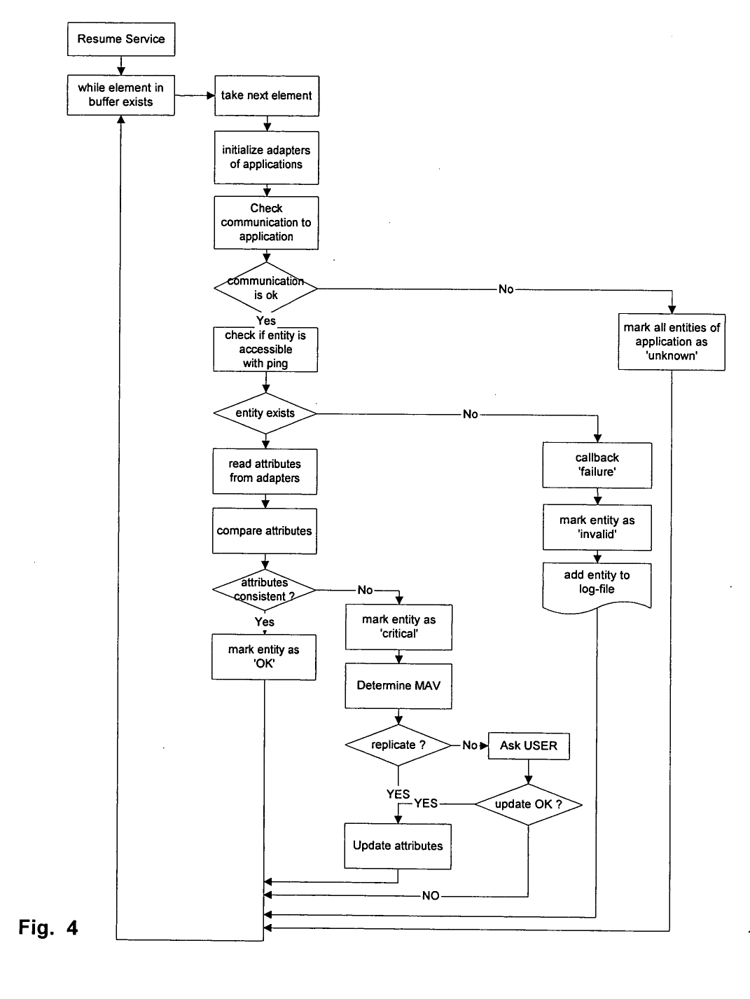

The attribute consistency service fulfills the following functionality (see FIG. 4):

As soon as there is an element in the input buffer, that element is taken and the adapters of the IT systems are initialized. For that purpose, entities from different source applications are grouped into a reference container during the engineering phase. The entities carry meta-information, such as its local identifier in order to access the entity in the local application, and an application identifier which allows the consistency service to direct any requests related to that entity to the correct adapter. The adapter of the IT system to be checked is initialized. Then the communication to the source application is checked by sending a service request (e.g. ping the machine the application is residing on, with defined return values: system: UP, entity: EXISTS) to the source applications. If the communication is not properly working, all entities of that particular application are marked as unknown. Otherwise, the entity for which the consistency of its attributes needs to be ensured is pinged by sending out a signal as described above. If the entity does exist and a return signal is sent back accordingly, the attributes are read from the different IT systems. The attributes read from the different applications are compared amongst each other. If the values are consistent, an OK can be loaded into the output means of the attribute consistency service. The calling application gets the OK and knows that the requested entity is available with all its attributes being consistent according to the reference entity.

If the values differ, the consistency needs to be restored by over-writing the attributes of the entity in the different IT systems with the MAV, which is computed as described above.

1. Method for ensuring consistency of attributes of entities stored in data sets of a multitude of different IT systems, whereas an attribute consistency service comprises an input buffer in which an entity, for which the consistency of its attributes needs to be ensured, can be placed, output means in which the result of the consistency validation can be stored, and communication means to communicate with the different IT systems, whereas an adapter for each of the IT systems allows communication between the attribute consistency service and the IT systems, such that a signal sent by the consistency service to verify the existence of a specific data set of an IT system can be sent back to the consistency service if that specific data set exists, and whereas a first storage device holds references to the entity in the data sets of the various IT systems such that the entity in a specific IT system can be addressed, and a second storage device holds references to the attributes of an entity in the data sets of the various IT systems such that the attributes of an entity in a specific IT system can be addressed, said method comprising the following steps:
loading the entity, for which the consistency of its attributes needs to be ensured, into the buffer of the consistency service,
reading the values of the attributes of the entity from the adapters of the various IT systems,
checking consistency of the attributes of the entity by comparing the values of the attributes read from the various IT systems, and
if any of the attributes of the entity are found to be inconsistent, restoring consistency of the attributes of the entity by overwriting the values of the attributes stored in the data sets of the various IT systems with a master attribute value, said master attribute value being determined according to a predefined algorithm.

2. Method as in claim 1, further comprising the following step: the attribute consistency service sending a signal to verify the existence of a specific data set of an IT system to the IT system holding the entity, for which the consistency of its attributes needs to be ensured, prior to reading the values from the attributes of the entity from the adapter, and aborting the consistency ensuring process if the signal is not being sent back to the consistency service.

3. Method as in claim 2, further comprising the following step: logging failure of consistency ensuring if the signal is not being sent back to the attribute consistency service by adding entity, for which the consistency of its attributes needs to be ensured, and the IT system, which was not replying to the signal, to a log file.

4. Method as in claim 2, further comprising the following step: the attribute consistency service checking communication to the IT system holding the data set to be verified prior to sending signal to verify the existence of the specific data set of that IT system.

5. Method as in claim 1, further comprising the following step: a multitude of entities to be validated for consistency being loaded into the buffer of the attribute consistency service, the attribute consistency service successively processing the entities, for which the consistency of its attributes needs to be ensured and storing consistency validating information in the output means.

6. Method as in claim 1, wherein the algorithm to determine the master attribute value of an attribute of an entity is stored as a function in the second storage device, and the attribute consistency service determines the master attribute value by calling the function with the attributes read from the various IT systems as function parameters.

7. Method as in claim 1, further comprising the following step: the attribute consistency service overwriting the values of the attributes stored in the data sets of the various IT systems with the master attribute value only after having called for and received a confirmation by a user or an overwriting confirmation application.

8. A computer program product loadable into an internal memory of a digital computer, comprising: computer program code means to make, when said program is loaded in the computer, the computer execute the method of any of claim 1.
